(19) United States
(12) Patent Application Publication
(10) Pub. No.: US 2008/0228590 A1
(43) Pub. Date: Sep. 18, 2008

(54) SYSTEM AND METHOD FOR PROVIDING AN ONLINE BOOK SYNOPSIS

(76) Inventor: Byron Johnson, Chicago, IL (US)

Correspondence Address: HOLLAND & KNIGHT LLP, 10 ST. JAMES AVENUE, 11th Floor, BOSTON, MA, 02116-3889, US

(21) Appl. No.: 12/034,735

(22) Filed: Feb. 21, 2008

Related U.S. Application Data
(60) Provisional application No. 60/894,535, filed on Mar. 13, 2007.

(51) Int. Cl. G06Q 30/00

(52) U.S. Cl. 705/26

(57) ABSTRACT

A method and computer program product for providing an online book synopsis include providing an electronic book accessible by a user. A synopsis of one or more portions of the electronic book are generated. The synopsis is made accessible to the user.

### CROSS-REFERENCE TO RELATED APPLICATIONS

This application claims the benefit of U.S. provisional patent application Ser. No. 60/894,535, filed Mar. 13, 2007, the entire disclosure of which is incorporated by reference.

### FIELD OF THE DISCLOSURE

The present disclosure relates to electronic books, and more specifically to a system and method for providing an online book synopsis of electronic books.

### BACKGROUND

Many tools and programs exist for helping students learn. Often, students benefit from a summary or synopsis of what they reading or writing. Some students are inclined to take copious notes, which may not necessarily help the studying process. For example, often the notes taken by the student may be nearly as long as the text to upon which the notes are based. In such a situation, the quantity of material that must be consumed by the student may be quite voluminous. Such students may realize minimal benefit from their notes.

Further, with the increasing integration of technology into educational settings, original material consumed by students is often in electronic form. Notes which may be taken by students while consuming the electronic material are often subsequently transcribed into an electronic form, increasing the number of steps undertaken by the student. As such, there exists a need for a teaching tool that includes the ability to generate a synopsis of a book or notebook that may be implemented by a student studying a particular subject, as well as a tool that enables the student to electronically access multiple books or notebooks.

### SUMMARY OF THE DISCLOSURE

According to an implementation, a method for providing an online book synopsis may include providing an electronic book accessible by a user. A synopsis of one or more portions of the electronic book may be generated. The synopsis may be made accessible to the user.

One or more of the following features may be included. The electronic book may be selected from a user-specific list of electronic books. The one or more portions of the electronic book may be selected from the group consisting of chapters, pages, paragraphs, and lines of text. The one or more portions of the electronic book may include one or more portions of the electronic book selected by the user. The electronic book may be an electronic notebook.

The synopsis may be saved to a user electronic book account. The synopsis may be rendered in at least one of an audio or a text based format.

According to another implementation, a computer program product resides on a computer readable medium having a plurality of instructions stored on it. When executed by a processor, the instructions cause the processor to perform operations including providing an electronic book accessible by a user. The computer program product also includes instructions for generating a synopsis of one or more portions of the electronic book. The synopsis is made accessible to the user.

One or more of the following features may be included. The electronic book may be selected from a user-specific list of electronic books. The one or more portions of the electronic book may be selected from the group consisting of chapters, pages, paragraphs, and lines of text. The one or more portions of the electronic book may include one or more portions of the electronic book selected by the user. The electronic book may be an electronic notebook.

The computer program product may also include instructions for saving the synopsis to a user electronic book account. The computer program product may also include instructions for rendering the synopsis in at least one of an audio or a text based format.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of an online book synopsis process coupled to a distributed computing network

FIG. 2 is a flowchart of a process executed by the online book synopsis process of FIG. 1.

FIG. 3 is a screen shot of a user interface screen rendered by the online book synopsis process and/or a client application of FIG. 1.

### DETAILED DESCRIPTION OF PREFERRED EMBODIMENTS

### System Overview

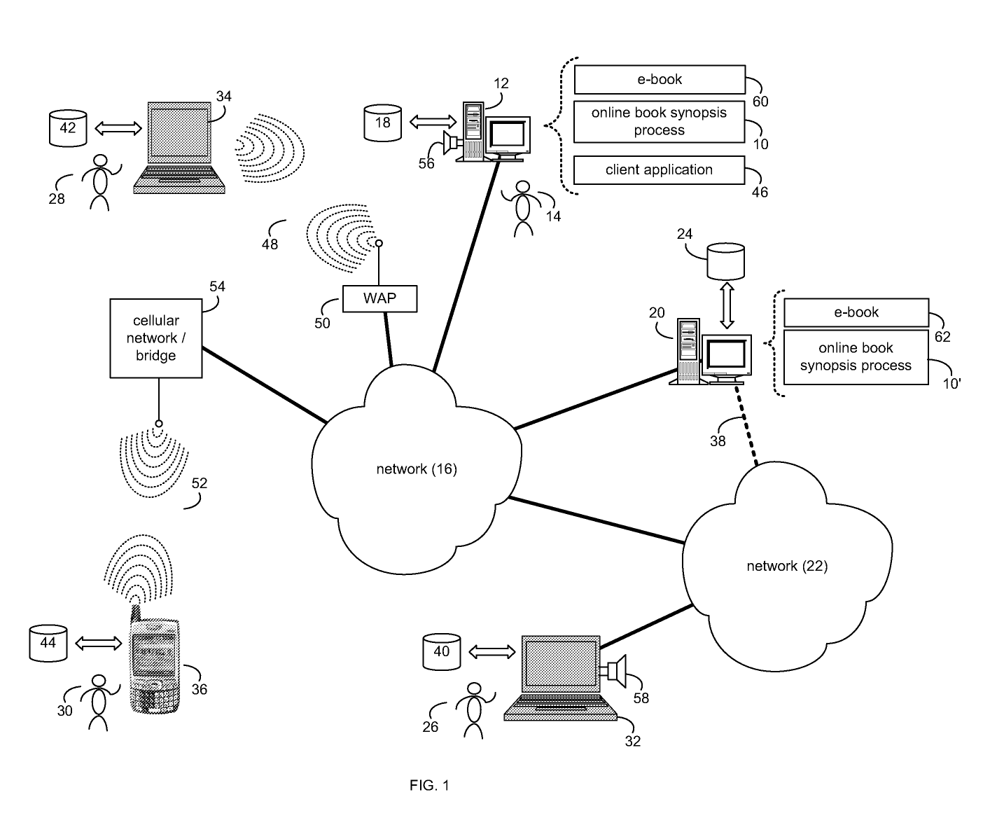

Referring to FIG. 1, there is shown an online book synopsis processes 10, 10′ that may provide an electronic book accessible by a user, and may generate a synopsis of one or more portions of the electronic book. The synopsis may be made accessible to the user. Online book synopsis process 10 may be a client-side application. Additionally/alternatively, online book synopsis process 10′ may be a server-side application.

As a client-side application, online book synopsis process 10 may reside on and be executed by a computing device, e.g., personal computer 12, which may be connected to network 16 (e.g., the Internet). The instruction sets and subroutines of online book synopsis process 10, which may be stored on a storage device 18 coupled to personal computer 12, may be executed by one or more processors (not shown) and one or more memory architectures (not shown) incorporated into personal computer 12. Storage device 18 may include but is not limited to: a hard disk drive; a tape drive; an optical drive; a RAID array; a random access memory (RAM); a read-only memory (ROM); a compact flash (CF) storage device, a secure digital (SD) storage device, and a memory stick storage device.

As a server-side application, online book synopsis process 10′ may reside on and be executed by server computer 20, which may be coupled to network 16. Examples of server computer 20 may include, but are not limited to: a single server computer, a series of server computers, a mini computer, and a mainframe computer, for example. Server computer 20 may execute a network operating system, examples of which may include but are not limited to: Microsoft Windows XP Server™; Novell Netware™; or Redhat Linux™, for example.

Server computer 20 may execute a web server application, examples of which may include but are not limited to: Microsoft IIS™, Novell Webserver™, or Apache Webserver™, that allows for HTTP (i.e., HyperText Transfer Protocol) access to server computer 20 via network 16. Network 16, and/or server computer 20, may be coupled to one or more secondary networks (e.g., network 22), examples of which may include but are not limited to: a local area network; a wide area network; or an intranet, for example.

The instruction sets and subroutines of server-side online book synopsis process 10′, which may be stored on a storage device 24 coupled to data server 20, may be executed by one or more processors (not shown) and one or more memory architectures (not shown) incorporated into server computer 20. Storage device 24 may include but is not limited to: a hard disk drive; a tape drive; an optical drive; a RAID array; a random access memory (RAM); a read-only memory (ROM); a compact flash (CF) storage device, a secure digital (SD) storage device, and a memory stick storage device.

As discussed above, the online book synopsis process may be a client-side application (e.g., client-side online book synopsis process 10), a server-side application (e.g., server-side online book synopsis process 10′), or a hybrid client-side/server-side application (e.g., including client-side online book synopsis process 10 and server-side online book synopsis process 10′). Accordingly, the manner in which the online book synopsis process is accessed may vary depending upon, at least in part, whether the online book synopsis process is a client-side application, a server-side application, or a hybrid client-side/server-side application.

While not shown, client-side online book synopsis process 10 may be associated with a variety of computing devices, e.g., notebook computer 32, laptop computer 34, and personal digital assistant 36, for example, in addition to personal computer 12. As described above, the instruction sets and subroutines of client-side online book synopsis process 10, which may be stored on a storage device (e.g., storage devices 40, 42, 44) coupled to the computing device (e.g., notebook computer 32, laptop computer 34, and personal digital assistant 36, respectively), may be executed by one or more processors (not shown) and one or more memory architectures (not shown) incorporated into the computing device. Storage devices 40, 42, 44 may include but are not limited to: a hard disk drive; a tape drive; an optical drive; a RAID array; a random access memory (RAM); a read-only memory (ROM); a compact flash (CF) storage device, a secure digital (SD) storage device, and a memory stick storage device.

If a client-side application, one or more users (e.g., users 14, 26, 28, 30) may access the client-side online book synopsis process 10 directly through the computing device on which the client-side online book synopsis process 10 is executed. Alternatively, server-side online book synopsis process 10′ may be accessed by users 14, 26, 28, 30 through network 16 or through secondary network 22. Server computer 20 (i.e., the computer that executes server-side online book synopsis process 10′) may be coupled to network 16 through secondary network 22, as illustrated with phantom link line 38.

The computing device (e.g., personal computer 12, notebook computer 32, laptop computer 34 and personal digital assistant 36) may execute a client application (e.g., client application 46 shown associated with personal computer 12) to access server-side online book synopsis process 10′. The client application (e.g., client application 46) may be, for example, a web browser (e.g., Microsoft Internet Explorer™ and Netscape Navigator™, for example) that may interface with server-side online book synopsis process 10′.

Additionally/alternatively, client-side online book synopsis process 10 may be accessed by a user (e.g., user 14, 26, 28, 30) using a client application (e.g., client application 46). In such an embodiment, client-side online book synopsis process 10 may be a stand-alone application that may interface with client application 46, or may be a plug-in or applet, that may be executed and/or accessed in the environment of client application 46.

Personal computer 12, notebook computer 32, laptop computer 34, and personal digital assistant 36 may each execute an operating system, examples of which may include but are not limited to Microsoft Windows™, Microsoft Windows Mobile™, Redhat Linux™, or a custom operating system.

The various computing devices (e.g., personal computer 12, notebook computer 32, laptop computer 34, and personal digital assistant 36) may be directly or indirectly coupled to network 16 (and/or to network 22). For example, personal computer 12 is shown directly coupled to network 16 via a hardwired network connection, and notebook computer 32 is shown directly coupled to network 22 via a hardwired network connection.

Laptop computer 34 is shown wirelessly coupled to network 16 via wireless communication channel 48 established between laptop computer 34 and wireless access point (i.e., WAP) 50, which is shown directly coupled to network 16. WAP 50 may be, for example, an IEEE 802.11a, 802.11b, 802.11g, Wi-Fi, and/or Bluetooth device that is capable of establishing wireless communication channel 48 between laptop computer 34 and WAP 50.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows, e.g., mobile phones, computers, and personal digital assistants to be interconnected using a short-range wireless connection.

Personal digital assistant 36 is shown wirelessly coupled to network 16 via wireless communication channel 52 established between personal digital assistant 36 and cellular network/bridge 54, which is shown directly coupled to network 16.

Computing device (i.e., client computer 12, notebook computer 32) may include one or more media input/output devices, e.g., audio components, such as speakers 56, 58.

### Online Book Synopsis Process

As discussed above, online book synopsis process 10, 10′ may be a client-side application, a server-side application, or a hybrid client-side/server-side application. Accordingly, the following disclosure is applicable to all variants of the online book synopsis process. The following discussion will generally describe client-side online book synopsis process 10, however this is for illustrative purposes only, and should not be construed as a limitation of the disclosure as other implementations (e.g., including, but not limited to, server-side online book synopsis process 10′ and a hybrid client-side/server-side only book synopsis process) may be equally utilized. Additionally, for the convenience of explanation, client computer 12 will be described. Such description is also not intended to be a limitation of this disclosure as other client electronic devices may be equally utilized.

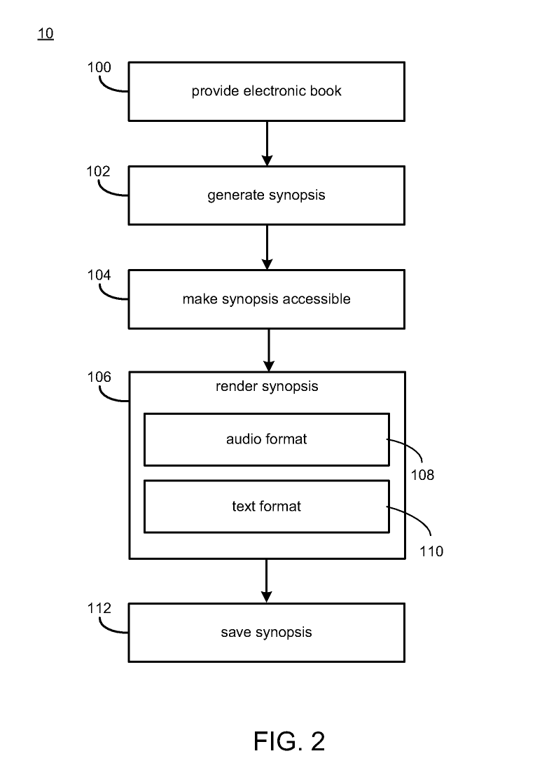

Referring also to FIG. 2, online book synopsis process 10 may provide 100 an electronic book accessible by a user. Online book synopsis process 10 may generate 102 a synopsis of one or more portions of the electronic book, and may make 104 the synopsis accessible to the user.

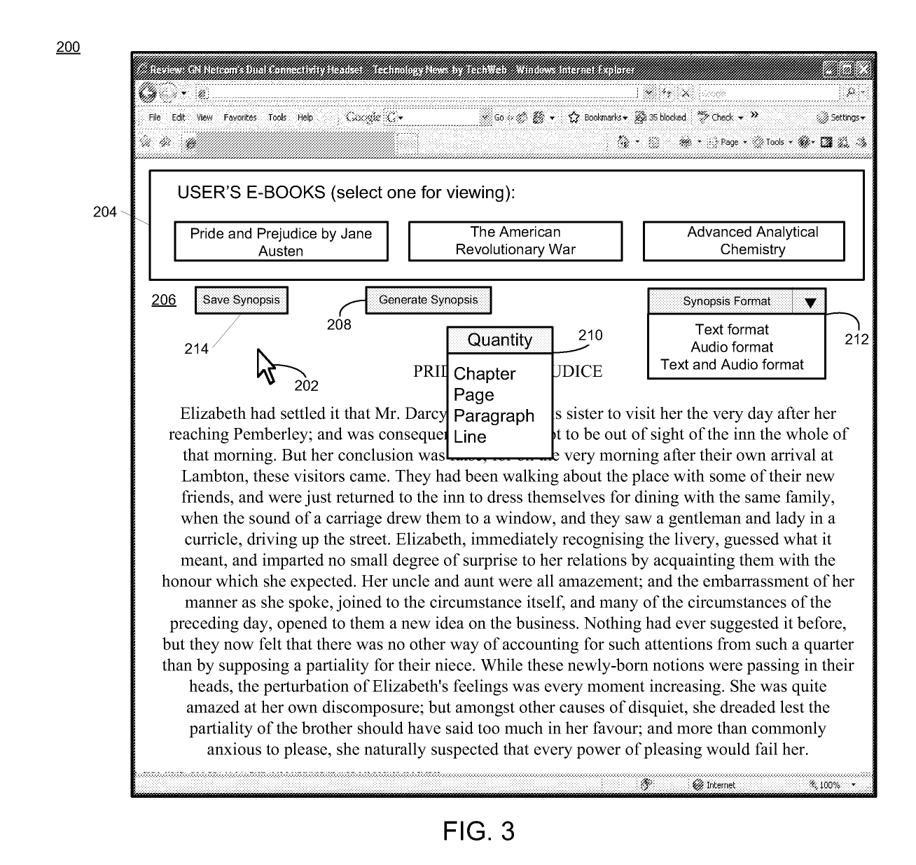

Referring also to FIG. 3, online synopsis process 10, alone or in conjunction with client application 46, may render user interface screen 200, which may include electronic book menu 204. Electronic book menu 204 may include title listings of one or more electronic books available to user 14. User 14 may select, e.g., using onscreen pointer 202, controlled by pointing device (such as a mouse; not shown), an electronic book title for viewing from electronic book menu 204. Selecting, via onscreen pointer 202, one of the electronic book titles for electronic book menu 204 may result in online synopsis process 10, alone or in conjunction with client application 46, rendering the selected electronic book (e.g., e-book 60, e-book 62 residing on client computer 12 and server computer 20, respectively). The selected electronic book may be displayed in reading pane 206 of user interface screen 200.

The one or more electronic books (e.g., e-books 60, 62) may include user-specific lessons that have been chosen as a lesson plan or curriculum for an individual user or class. For example, a teacher may require that her students use online book synopsis process. When each student logs in, electronic book menu 204 may include lessons that the teacher chose for the student individually, or for her class as a whole. In this way, electronic book menu 204 may be custom-tailored to individual students or for whole classes.

It may be useful to a user (e.g., user 14) to see a synopsis or summary of the electronic book that the user is reading. This may be helpful in that some students may be intimidated by large quantities of text, and/or may find the subject matter of the electronic book confusing, etc. By presenting a reading assignment in small, synopsized increments, the reading task may feel less daunting and more accomplishable for such students. Accordingly, online book synopsis process 10 may generate 102 a synopsis of one or more portions of electronic book (e.g., e-book 60, e-book 62). User 14 may select, e.g., using onscreen pointer 202, generate synopsis button 208 in user interface screen 200. Selecting generate synopsis button 208 may result in online book synopsis process 10 rendering quantity selection menu 210. Quantity selection menu 210 may include one or more quantity options (namely “chapter”, “page”, “paragraph”, and “line”). While quantity selection menu 210 is shown including four options, this is for illustrative purposes only, and is not intended to be a limitation of the disclosure as the number and nature of the quantity selection options may vary according to user need and design criteria. Online book synopsis process 10 may allow user 14 to select the desired quantity of the electronic book to be synopsized, e.g., by selecting, via onscreen pointer 202, the desired quantity option from quantity selection menu 210.

In addition/as an alternative to quantity selection menu 210, the quantity of the electronic book to be synopsized may be selected, e.g., from a static list, a series of buttons or similar selection feature displayed in user interface screen 200. Further, user 14 may manually select the portion or portions of the electronic book displayed in that the user would like synopsized. For example, user 14 may position onscreen pointer 202 at a beginning or an ending of a portion of the electronic book displayed in reading pane 206. User 14 may highlight the desired portion of the electronic book to be synopsized by holding down the left mouse button and dragging onscreen pointer 202 to highlight the desired portion of the electronic book.

In addition/as an alternative to the electronic book being a text book, treatise or literature, the one or more electronic books may be an electronic notebook. For example, a user may generate notes in an electronic format, which may be stored in the form of an electronic notebook. The electronic notebook may include, for example, notes taken by the user while reading an electronic book (e.g., one of the one or more electronic books accessible vie online book synopsis process 10 and/or client application 46). In the context of the electronic book being an electronic notebook, online book synopsis process 10 may provide an option to the user to generate 102 a synopsis of the electronic notebook, e.g., which may be associated with the electronic book, for example.

In response to selecting generate synopsis button 208 and selecting a desired quantity of the electronic book to be synopsized (e.g., from quantity selection menu 210 and/or manually), online book synopsis process 10 may generate 102 a synopsis of at least a portion of the electronic book. The synopsis may be generated 102 based upon, for example, key words within the selected portion of the electronic book, selected from stored predefined synopsis content, for example.

Online book synopsis process 10 may make 104 the synopsis accessible to the user. For example, online book synopsis process 10 may render the synopsis via client computer 12. Alternatively, online book synopsis process 10 may email the synopsis to user 14 via one or more of network 16, 22, print the synopsis on a printer (not shown) connected to the computing device, or the like. Rendering 106 the synopsis may include rendering 108 the synopsis in an audio based format and/or rendering 110 the synopsis in a text based format. For example, some users may benefit from hearing the synopsis or from being able to listen to the synopsis as they read the text of the synopsis. User (e.g., user 14) may choose the format in which online book synopsis process 10 may render the synopsis by, for example, selecting the preferred format from a list, e.g. synopsis format drop down list 212, e.g., by selecting the desired format using onscreen pointer 202. While synopsis format drop down list 212 is shown only including three options (namely “Text format”, “Audio format”, and “Text and Audio format”) this is for illustrative purposes only, and is not intended to be a limitation of this disclosure as the number and nature of the options may vary according to design preference and user need. When rendered 110 in text format, the synopsis may be displayed in user interface screen 200 (e.g., in reading pane 206). Similarly, online book synopsis process 10 may render 108 the synopsis in audio format, e.g., via audio components (e.g., speakers 56) associated with the client electronic device (e.g., client computer 12). Rendering 108 the synopsis in audio format may include the use of a conventional text-to-speech software package, as is known in the art.

Online book synopsis process 10 may save 112 the synopsis to a user electronic book account. For example, user 14 may select, via onscreen pointer 202, save button 214. Upon selecting save button 214, online book synopsis process 10 may save the synopsis to the user electronic book account either locally on client computer 12 (e.g. on storage device 18), remotely on server computer 20 (e.g., on storage device 24).

A number of implementations have been described. Nevertheless, it will be understood that various modifications may be made. Accordingly, other implementations are within the scope of the following claims.

What is claimed is:

1. A method comprising:
providing an electronic book accessible by a user;
generating a synopsis of one or more portions of the electronic book; and
making the synopsis accessible to the user.

2. The method of claim 1, wherein the electronic book is selected from a user-specific list of electronic books.

3. The method of claim 1, wherein the one or more portions of the electronic book are selected from the group consisting of chapters, pages, paragraphs, and lines of text.

4. The method of claim 1, wherein the one or more portions of the electronic book include one or more portions of the electronic book selected by the user.

5. The method of claim 1, further comprising saving the synopsis to a user electronic book account.

6. The method of claim 1, further including rendering the synopsis in at least one of an audio or a text based format.

7. The method of claim 1, wherein the electronic book is an electronic notebook.

8. A computer program product residing on a computer readable medium having a plurality of instructions stored thereon which, when executed by a processor, cause the processor to perform operations comprising:
providing an electronic book accessible by a user;
generating a synopsis of one or more portions of the electronic book; and
making the synopsis accessible to the user.

9. The computer program product of claim 8, wherein the electronic book is selected from a user-specific list of electronic books.

10. The computer program product of claim 8, wherein the one or more portions of the electronic book are selected from the group consisting of chapters, pages, paragraphs, and lines of text.

11. The computer program product of claim 8, wherein the one or more portions of the electronic book include one or more portions of the electronic book selected by the user.

12. The computer program product of claim 8, further including saving the synopsis to a user electronic book account.

13. The computer program product of claim 8, further including rendering the synopsis in at least one of an audio or a text based format.

14. The computer program product of claim 8, wherein the electronic book is an electronic notebook.
